(19) United States
(12) Patent Application Publication
(10) Pub. No.: US 2010/0140880 A1
(43) Pub. Date: Jun. 10, 2010

(54) PISTON RING

(76) Inventors: Toshikatsu Hayashi, Niigata (JP); Gyo Muramatsu, Niigata (JP); Miyuki Usui, Niigata (JP); Yoshinari Watanabe, Niigata (JP); Hiroaki Saitou, Niigata (JP)

Correspondence Address: CERMAK KENEALY VAIDYA & NAKAJIMA LLP, 515 EAST BRADDOCK RD SUITE B, Alexandria, VA, 22314, US

(21) Appl. No.: 12/516,208

(22) PCT Filed: Nov. 22, 2007
(86) PCT No.: PCT/JP2007/072636

§ 371 Date: Feb. 22, 2010

(30) Foreign Application Priority Data
Nov. 24, 2006 (JP) 2006-317118

(51) Int. Cl. F16J 9/26; F02F 5/00

(52) U.S. Cl. 277/442

(57) ABSTRACT

A piston ring mounted in the ring groove of an aluminum alloy piston does not cause aluminum adhesion during the long-term use. The piston ring includes a resin film deposited on at least one of an upper face and a lower face. The resin film contains from 0.5 to 20% by volume of carbon black particles and from 3 to 30% by volume of solid lubricant particles with respect to the total volume of the resin film. The carbon black particles preferably contain one or both of graphitized carbon black particles and composite graphite black particles.

### TECHNICAL FIELD

The present invention relates to piston rings for internal combustion engines, and in particular, to a technology to prevent the adhesion between piston rings and an aluminum alloy, the base material of the piston, caused by the impact and sliding of the piston rings against the piston.

### BACKGROUND ART

In an internal combustion engine, a piston reciprocates as the fuel explodes within a combustion chamber, causing repeated impact between the surface in the piston ring grooves (which will be referred to as “ring groove surface,” hereinafter) of the piston and piston rings. In addition to this, piston rings can freely move along their circumference during operation of the internal combustion engine, so that the ring groove surface slides against the surface of the piston rings along the circumference of the piston.

In a gasoline engine, the explosion causes the temperature near the top ring to reach as high as 190 to 220° C., and even about 250° C. in modern high power engines. In diesel engines, the temperature near the top ring may rise even higher. As the ring groove surface of a piston is repeatedly hit by a piston ring under such a high temperature condition, it undergoes fatigue breakage. As a result, the surface of the piston flakes off, forming debris of the base material of the piston, or an aluminum alloy. The debris of aluminum alloy or the aluminum alloy surface that newly appears within the ring grooves as a result of the flaking off of the debris come in contact with the upper face or the lower face of the piston ring as the piston ring collides with the ring groove surface. This, when combined with the sliding of the piston ring, causes aluminum alloy debris to adhere to the sides of the piston ring, or causes the piston ring to securely adhere to the newly exposed aluminum alloy surface. This is a phenomenon known as “aluminum adhesion.”

In an advanced stage of aluminum adhesion, the piston ring sticks to the piston within the piston groove, resulting in the loss of sealing performance of the piston ring. If the gas sealability, one of the properties that define the sealing performance of the piston ring, is lost, the high pressure combustion gas leaks from the combustion chamber into the crank chamber, a phenomenon known as “blow-by.” This decreases the engine power. If the oil sealability is lost, the oil consumption increases. In addition, the debris of aluminum alloy adhering to the upper face or the lower face of the piston ring form bumps on the surfaces of the piston ring or make the ring groove surface rough. As a result, the seal between the upper and/or lower faces of the piston ring and the ring groove surface will be broken. This also increases the amount of “blow-by.”

To prevent the aluminum adhesion, several methods have been proposed that prevent the top ring from coming into direct contact with the aluminum alloy, the base material of the piston.

One improvement that is made on the side of the piston is to anodize the ring groove surface (anodized aluminum treatment) and to fill the pores formed during the process with a lubricant (see, for example, Patent Document 1). The anodization process leaves' a hard oxide film, primarily composed of aluminum oxide, on the ring groove surface. This prevents the flaking off of aluminum alloy, the base material of the piston, and, thus, the resulting adhesion of aluminum alloy to the piston ring. Nevertheless, the anodization of piston is costly. Furthermore, the treated surface is so hard that the scratches formed during the working process tend to last, leading to an increase in the amount of the blow-by during the early use.

Improvements are also made on the side of the piston ring. For example, one piston ring includes a phosphate film or a ferrous-ferric oxide film deposited, for example, on the lower face of the piston ring, and a heat-resistant, wear-resistant resin film deposited on the first film. The heat-resistant, wear-resistant resin film includes a tetrafluoroethylene resin or oxybenzoylpolyester resin and a solid lubricant (such as molybdenum disulfide, graphite, carbon, and boron nitride) dispersed in the resin (see, for example, Patent Document 2). Another piston ring includes, on its upper and lower faces, a film including a solid lubricant, such as molybdenum disulfide, dispersed in a heat-resistant resin, such as epoxy resin, phenol resin, polyamide resin, and polyimide resin (see, for example, Patent Document 3). The amount of molybdenum disulfide to serve as the solid lubricant is preferably contained in the amount of from 60 to 95 mass %. The solid lubricant added in the film can reduce the friction coefficient between the piston ring groove and the side wall of the piston ring by the cleavage of the lubricant.

Each of the above-described approaches employs a solid lubricant (such as molybdenum disulfide and graphite) that cleaves and wears itself to reduce the friction coefficient of the film. The films containing such a lubricant tend to wear off in a relatively short period of time. New engines are being developed that achieve high combustion pressure for environmental protection and are designed with small piston top lands. In these engines, the temperature near the top ring groove can rise even higher than in conventional engines, so that the film may wear off before the piston ring and the ring groove surface conform to each other. In addition, aluminum alloys tend to soften in a high temperature environment, resulting in an increased frequency of aluminum adhesion in modern engines.

Another piston ring uses a highly heat-resistant resin in its resin coating to improve aluminum-adhesion resistance (see, for example, Patent Document 4). Though aluminum adhesion can be prevented to some extent by the use of heat-resistant or wear-resistant resins, the solid lubricant particles dispersed in the film causes premature wear-off of the film, making it difficult to avoid aluminum adhesion for a prolonged period of time.
Patent Document 1 Japanese Patent Application Laid-Open No. Sho 63-170546
Patent Document 2 Japanese Utility Model Application Laid-Open No. Sho 60-82552
Patent Document 3 Japanese Patent Application Laid-Open No. Sho 62-233458
Patent Document 4 Japanese Patent Application Laid-Open No. Hei 07-63266

### DISCLOSURE OF THE INVENTION

### Problems to Be Solved by the Invention

Accordingly, it is an aspect of the present invention to provide a piston ring that is mounted in the ring groove of an aluminum alloy piston and does not cause aluminum adhesion during the long-term use.

### Means for Solving the Problems

To achieve the foregoing aspect, the piston ring of the present invention includes a resin film on at least one of upper and lower faces thereof. The resin film contains carbon black particles and solid lubricant particles in amounts of from 0.5 to 20% and from 3 to 30%, respectively, relative to the total volume of the resin film.

### Effect of the Invention

In the piston ring of the present invention, the optimum amounts of the carbon black particles and the solid lubricant particles dispersed in the resin film serve to reduce the friction coefficient while ensuring high wear resistance. Not only does this reduce the wear of the base material of the piston, but it also reduces the shear force acting at the interface between the base material of the piston ring and the resin film. As a result, the flaking-off of the film can be prevented. Since the resin film of the present invention remains intact for a prolonged period of time, it enables the long-term prevention of the aluminum adhesion.

### BEST MODE FOR CARRYING OUT THE INVENTION

The piston ring of the present invention will now be described in detail.

### [1] Base Material of the Piston Ring

The base material of the piston ring may be any suitable material. A suitable material needs to have moderate strength to withstand the repeated impact against the ring groove surface. Any material commonly used in piston rings for pistons of internal combustion engines may be used. Preferred base materials include steel, martensite stainless steel, austenite stainless steel, and high-grade cast iron. The surface of the base material may be subjected to a certain treatment to increase wear resistance. For example, the surface of stainless steel base materials may be nitrided while the surface of cast iron base materials may be treated with hard chromium plating or nonelectrolytic nickel plating.

### [2] Piston Ring Foundation Treatment

Examples of treatments for forming foundation for the resin film of the present invention on the base material of the piston ring will now be described.

A phosphate film that shows high adhesion to a resin may be deposited on the surface of the base material in advance to improve the adhesion of the resin film of the present invention to the base material. Examples of such a phosphate film include zinc phosphate films, manganese phosphate films, and calcium phosphate films. Aside from the phosphate film, techniques such as conversion coating or oxide films may also be used to similarly improve the adhesion. Since conversion coating cannot be applied to piston rings surface-treated with hard chromium plating or nonelectrolytic nickel plating, such rings are preferably treated for foundation by removing organic or inorganic contaminants in order to ensure adhesion of the film. Alternatively, the surface of the base material may be blasted for a foundation treatment. The blast treatment may also be used to adjust the surface roughness.

### [3] Pre-Treatment for Resin Film Deposition

No particular pre-treatments are necessary if the piston rings have just been subjected to the conversion treatment. However, if oil or other unwanted materials stick to the surface of the piston rings during long-term storage, for example, the surface is preferably washed with an organic solvent. The surface of the piston rings may be pre-treated with a silane-coupling agent to improve adhesion to the resin film. Epoxy-based or amino-based silane-coupling agents that have high boiling points are suitable for use with the piston rings.

### [4] Resin Film

The resin film of the present invention is deposited on the upper face and/or the lower face of a piston ring, the surface that is perpendicular to the axis of the piston and collides with and slides against the ring groove of the piston. In the present invention, carbon black particles and solid lubricant particles are mixed and dispersed in a resin film material. The resulting resin material is applied to the surface of the base material of the piston ring and cured to form a film on the surface. The optimum amounts of the hard particles present in the film and the reduced friction coefficient ensure wear resistance of the film and prevent the base material of the piston from wearing off within the ring grooves. The resin film of the present invention may be deposited not only on the surfaces described above, but on other surfaces of the piston ring that slide against an aluminum alloy (such as outer periphery of the piston ring).

In the present invention, the carbon black particles and the solid lubricant particles dispersed in the resin film serve to reduce the friction coefficient of the film while ensuring high wear resistance of the film. The dispersed carbon black particles form a higher-order structure in which the particles form a number of aggregates (primary aggregates) that are fused in a chain. This structure helps improve the rigidity of the film. Nano-spaces are also formed within the higher order structure and ensure oil retention of the film. On the other hand, the solid lubricant particles between the crystalline particles cleave to cause the interlayer sliding. As a result, a lubrication phase is formed on the surface of the piston ring, facilitating the lubrication of the resin film. If the solid lubricant particles are added alone, the cleaved particles decrease the wear resistance of the resin film: Some particles that cleave to a larger magnitude can damage the ring groove surface. The present invention takes advantage of the solid lubrication phase formed on the rigid film and oil retention of the film. The synergic effect of these factors imparts to the resin film a higher wear resistance than the film containing a single component alone. In addition, a soft film may deform upon sliding, leading to an increase in the resistance and the friction coefficient. By dispersing carbon black in the film, the film can be made a hard film with high rigidity. This helps maintain low friction coefficient. Common solid lubricants such as molybdenum disulfide tend to absorb water and other highly polar molecules. This prevents the interlayer sliding and increases the friction. When this occurs, the tendency of the solid lubricant to cleave decreases and the lubricant remains large particles that can abrade the base material against which the film rubs or the resin film. In the present invention, the carbon black particles containing nano-spaces and the resulting oil film phase effectively eliminate the large solid lubricant particles from the film surface. As a result, the wear of the base material of the piston or the resin film can be reduced.

Carbon black particles are hard particles and can serve as an abrasive by themselves. Thus, the carbon black particles optimally abrade the ring groove surface and improve the conformity of the surface to the upper or the lower face of the piston ring. If carbon black particles are used alone, they continuously abrade the ring groove surface over time beyond the desired degree. This may lead to an increase in the amount of the blow-by. By adding the solid lubricant, along with the carbon black particles, to the film, however, the abrasive effect of the carbon black particles can be optimized, so that the ring groove surface can be abraded to a desired degree and maintained for a prolonged period of time without being worn away.

Although increasing the rigidity of the film makes the film less susceptible to wear, it in turn increases the shear force acting at the interface between the base material of the piston ring and the resin film, making the film more likely to peel due to fatigue. In particular, the films in which the carbon black particles alone are dispersed tend to peel and have limited long-term durability. In the present invention, the solid lubrication phase and the oil film phase formed on the outermost surface of the film serve to keep the friction coefficient small. As a result, the shear force acting at the interface can be reduced and the peel resistance of the film can be improved. This ensures the durability of the film.

Examples of the carbon black for use in the present invention include channel black, furnace black, acetylene black, thermal black, lamp black, ketjen black, and graphitized carbon black. Composite graphite black is also preferably used. Carbon blacks with a primary particle size of 10 nm to 500 nm are commercially available. Those sized 10 nm to 200 nm, more preferably 10 nm to 100 nm, are suitable for use in the present invention. Unlike graphite, carbon black particles are hard particles that do not cleave. For this reason, they are preferably provided as nano particles since large particles can damage the base material of the piston.

Primary particles of carbon black have a structure in which carbon crystals having quasi-graphite structures are concentrically oriented on the outer surface. By subjecting the primary particles to the graphitization process (treatment at a high temperature of 2000 to 3000° C. in an inert atmosphere), the crystals in the particles grow from a globular to a polyhedral shape to form graphitized carbon black having the outer surface covered with a thick quasi-graphite structure. Graphitized carbon black is suitable for the piston ring film of the present invention that is exposed to high temperature environments and is required to have wear resistance. The graphitized carbon black is a kind of carbon black of which surface has been graphitized. Since, the graphite on the surface comprises nano-particles (the film in which graphitized carbon black is dispersed contains dispersed graphitized nano-particles), the lubrication and heat resistance of the resin film can be improved without causing the problem of cleavage as seen in the solid lubricant graphite. Commercially available products of graphitized carbon black include Toka Black #3800, #3845 and #3855 (trade name, manufactured by Tokai Carbon).

A preferred carbon black particle for use in the present invention is composite graphite black. Composite graphite black includes primary nano-particles with the outer layer and the interior thereof being formed primarily of a metal carbide. It includes aggregates with the outer layer formed of a metal carbide layer with higher hardness. As in the typical carbon blacks, the composite graphite black includes aggregates and can thus form a higher order structure that provides similar effects. The metal carbide deposited on the outer layer may be a B-based, Si-based or Ti-based metal carbide. These metal carbides are harder than ordinary carbon blacks and can thus provide abrasive effect in small amounts.

It is known that silane-coupling agents, widely known strong coupling agents, do not normally affect carbon black. When used with a composite graphite black, however, silane-coupling agents act to improve the adhesion of the composite graphite black to a resin because of TiC or SiC that forms the outer layer of the composite graphite black. As a result, the is wear resistance of the film can be improved. Commercial products of composite graphite black are available from Nippon Steel Chemical Carbon.

In order for carbon black particles to be dispersed in a resin material, their surface may be subjected to a treatment by coupling agents, plasma treatment, or oxidization to improve wetting with the resin and adhesion to the resin. A polymer pigment dispersant may also be added to facilitate dispersion of the carbon black particles. Addition of a dispersant having basic functional groups such as amino group is particularly effective since acidic functional groups, such as carboxyl group and phenol hydroxyl group, are remaining on the surface of the carbon black.

The solid lubricant particle for use in the present invention is composed of at lease one selected from the group consisting of molybdenum disulfide, graphite, boron nitride, and fluorine resin.

The resin material used as the film base is preferably a heat-resistant polymer that has aromatic rings or aromatic heterocyclic rings in its backbone. Specifically, the heat-resistant polymer is a non-crystalline polymer having a glass transition temperature of 190° C. or above or a crystalline or liquid crystal polymer having a melting point of 190° C. or above since the temperature near the piston ring grooves can reach 190° C. or higher. Specific examples of such heat-resistant polymer include polyimides, polyetherimides, polyamideimides, polysulfones, polyethersulfones, polyarylates, polyphenylene sulfides, polyetheretherketones, aromatic polyesters, aromatic polyamides, polybenzimidazoles, polybenzoxazoles, aromatic polycyanurates, aromatic polythiocyanurates, and aromatic polyguanamines, and a mixture or a composite containing at least one of them. An inorganic substance such as silica, alumina, titania, and zirconia may be dispersed in these resin materials at a molecular level. The so-obtained organic-inorganic hybrid resins can further improve the heat resistance and the strength of the resin film, as well as the adhesion of the resin film to the base material of the piston ring. Resins that have a glass transition point of 250° C. or above and are soluble in organic solvents, such as polyimides and polyamideimides, are more preferred since the temperature near the ring grooves can in some cases reach as high as 250° C. or above and in view of making a coating material from the resin material containing these components. These resins are commercially available as varnishes. Examples of polyimides include U varnishes (Ube Industries) and HCI series (Hitachi Chemical). Examples of polyamideimides include HPC series (Hitachi Chemical) and VYLOMAX (TOYOBO). Composeran H800/H900 series, hybrid mixtures of a polyimide or a polyamideimide and silica, are also available from Arakawa Chemical Industries.

The amounts of the carbon black particles and the solid lubricant particles are preferably from 0.5 to 20% and from 3 to 30% by volume of the film, respectively. More preferably, the amounts of the carbon black particles and the solid lubricant particles are from 2 to 15% and from 5 to 20% by volume of the film, respectively.

The carbon black particles present in amounts less than 0.5% cause insufficient formation of the higher order structure, and thus, an insufficient volume of the nano-spaces formed. As a result, the resulting film cannot achieve sufficient oil retention. The film also has a decreased heat dissipation performance and a decreased wear resistance, leading to premature wearing and adhesion of the film. In addition, the film loses the required rigidity. Conversely, the carbon black particles present in amounts exceeding 20% make the film so abrasive that the ring groove surface will be damaged during the long-term use.

The solid lubricant particles cannot provide sufficient lubrication when present in amounts less than 3% but decrease the wear resistance of the film because of their cleavage when is present in amounts greater than 30%.

### [5] Deposition of Resin Film

The resin film may be deposited on the piston ring by any suitable technique. For example, techniques such as spray coating, dip coating, roll coating, electrostatic painting, electropainting, and printing can be used to apply a resin material containing the necessary components to the surface of the piston ring. After application of the resin material, the piston ring may be treated with heat to cure the resin material, for example. The temperature for the heat treatment is preferably from 150° C. to 500° C. and more preferably from 180° C. to 400° C. though the temperature may vary depending on the type of the resin used. If the temperature for the heat treatment is below 150° C., then the resin material does not cure properly, resulting in an insufficient wear resistance. If the temperature for the heat treatment is above 500° C., then the resin and the dispersed particles may decompose or, depending on the type of the base material, the piston ring may deform. At this temperature range, certain types of phosphates may decompose, which causes the peeling of the resin film.

The resin film is preferably 0.5 μm to 40 μm thick and more preferably 2 μm to 15 μm thick. The film having a thickness of less than 0.5 μm tends to wear prematurely, whereas the film having a thickness of greater than 40 μm makes it difficult for the piston ring to be mounted on the piston.

### EXAMPLES

The advantages of the present invention will now be described in further detail in the following examples.

### Example 1

### [1] Preparation of Wear Test Piece

A 60 mm (L)×10 mm (W)×5 mm (T) SK-3 piece was polished to Rz (JIS84)=0.8 μm to 1.5 μm. The test piece was degreased in an alkali and was then immersed in an aqueous manganese phosphate solution at approximately 80° C. for about 5 minutes to make a wear test piece that has an approximately 2 μm-thick manganese phosphate film deposited on its entire surface.

### [2] Preparation of Piston Ring

A piston ring was produced from a low-chromium steel commonly used in the production of piston rings. An approximately 30 μm-thick CrN film was deposited on the outer periphery of the piston ring by ion plating. The resulting piston ring had a nominal diameter of 73 mm, a thickness (being the width in the radial direction) of 2.3 mm and a width (being the width in the axial direction) of 1.0 mm. This piston ring was degreased in an alkali and was immersed in an aqueous manganese phosphate solution at approximately 80° C. for about 5 minutes to deposit an approximately 2 μm-thick manganese phosphate film on the surface of the piston ring other than its outer periphery.

### [3] Preparation of Coating Material

A polyamideimide hybrid resin (HR16NN, TOYOBO) was diluted with N-methyl-2-pyrrolidone. To this solution, carbon black powder and solid lubricant powder were added and the resulting mixture was stirred for several hours to obtain a coating material in which the fillers were dispersed uniformly. In the same manner, 12 types of coating materials were prepared by varying the added amounts of carbon black powder and solid lubricant powder(Examples 1 to 12). As Comparative Example 1, a coating material containing only 10 vol % carbon black powder but no solid lubricant powder was also prepared.

The carbon black powder used was graphitized black (Toka Black #3845 (Tokai Carbon), primary particle size=40 nm) (CB-1). Another type of carbon black powder was also used (CB-2) (SiC-based composite graphite black (Nippon Steel Chemical lo Carbon, primary particle size=50 nm) wet-treated with a silane-coupling agent (KBM573, Shin-Etsu Chemical)).

The solid lubricant powder used was a 1:1 mixture (by volume) of molybdenum disulfide powder (MoS2 C powder, DAIZO) and a graphite powder having an average particle size of 2 μm (USSP-D, Nippon Graphite Industries).

### [4] Deposition of Film

Each of the coating materials prepared in [3] was applied by spray coating to one side of the wear test piece prepared in [1] and both upper and lower faces of the piston ring prepared in [2]. The test piece and the piston ring were dried and cured for 1 hour at 250° C. In this manner, five wear test pieces and five piston rings were prepared for each coating material. The thicknesses of the films deposited on the wear test pieces and the piston rings were approximately 10 μm and approximately 5 μm, respectively.

### [5] Engine Test

The resin film-coated piston rings were used in an engine test using a 1.3-liter, 4-cylinder engine with aluminum alloy pistons. The piston rings prepared in the steps [1] to [4 ] were used as the top rings and mounted in the top ring groove in two of the four cylinders (for example, the first and the third cylinders). Cast iron-made second rings and assembled oil rings were also mounted in the corresponding ring grooves. In order to confirm that the engine was operated under the same condition in each test, piston rings coated with the film of Comparative Example 1 (containing 10 vol % carbon black alone) were mounted to the remaining cylinders (for example, the second and the fourth cylinder) during each test. To avoid rating errors caused by the variation between the cylinders, the positions of the cylinders having the piston rings of Comparative Example 1 were alternately changed between the first/the third and the second/the fourth from one test to the next. The conditions for operation were as follows:
RPM: 5700 rpm
Load: 4/4
Operation time length: 400 hours

### [6] Measurement of Friction Coefficient

Using a reciprocating wear tester, the friction coefficient of the wear test pieces was measured. Specifically, each resin-coated wear test piece was reciprocated while a 4.5 mm aluminum ball was pressed against it with a predetermined load. The frictional force was indicated by the distortion gauge mounted on an arm that holds the aluminum ball. The friction coefficient was derived from the frictional force and the test load. The conditions for the test were as follows:
Test temperature: 260° C.
Stroke: 40 mm
Slide speed: 70 mm/sec
Lubrication: None
Number of reciprocation: 250

After the testing, the sample piece was removed and washed by sonication in ethanol to remove abraded powder. The piece was then dried, cooled and analyzed by a roughness meter for the profile along its short axis to determine the cross-sectional area of the wear track formed in the wear test. The profile of the test piece was measured at 3 points for each wear track and the wear track with the largest cross-sectional area was determined as the wear of the film.

### [7] Test Results

The results of the engine test and the friction wear test are shown in Table 1. The ratings shown in Table 1 were based on the following criteria:
Groove wear: none (A); observed but minor (B); observed (C).
Adhesion: aluminum adhesion was observed (B); not observed (A).
Wear amount: less than 300 μm² (A); 300 to less than 1000 μm² (B); more than 1000 μm² (C).
Ratings: excellent (AA); good (A); moderate/acceptable (B); unacceptable (C).

The results of the engine test and the friction wear test are shown in Table 1 for each film composition (with the amounts of carbon black particles and solid lubricant particles). The results of the engine test indicate that the groove wear was observed but minor in the resin films containing 0.5 vol % to 2 vol % (meaning within the predetermined range) of carbon black particles regardless of the amount of the solid lubricant particles present (Examples 1 to 5). The results of the friction wear test similarly indicate that the wear was not so significant in these films, demonstrating that these films are of good quality and suitable for use. For the films containing 2 vol % to 15 vol % of the carbon black particles, both the peeling and the adhesion were observed when the amount of the solid lubricant particles was small (Comparative Example 4). However, neither the groove wear nor the aluminum adhesion was observed in these films when the amount of the solid lubricant particles was 3 vol % or more (Examples 6 to 10 and Comparative Example 7). The film containing more than 30 vol % of the solid lubricant particles wore significantly in the friction wear test. Minor groove wear was observed when the amount of the carbon black particles exceeds 15 vol %. The groove wear became significant when the amount of the carbon black particles exceeds 20 vol %. The resin film containing a composite graphite black as the carbon black particles showed a high groove-wear and wear resistance despite the relatively small amount of the carbon black particles used (Example 13). This film proved particularly effective in preventing aluminum adhesion.

TABLE 1

| | Carbon | | | | Engine test | | Friction wear test | | |
|---|---|---|---|---|---|---|---|---|---|
| | black content | | Solid lubricant | | Groove | | Wear | Friction | |
| | (CB) (vol %) | | content (vol %) | | wear | Adhesion | amount | coefficient | Ratings |
| Example 1 | CB-1* | 0.6 | MoS2 + | 4 | B | A | B | 0.12 | B |
| Example 2 | | 0.6 | Graphite | 8 | B | A | B | 0.11 | B |
| Example 3 | | 0.6 | powder | 15 | B | A | B | 0.07 | A |
| Example 4 | | 0.6 | | 23 | B | A | B | 0.05 | A |
| Example 5 | | 0.6 | | 28 | B | A | B | 0.05 | A |
| Example 6 | | 2 | | 5 | A | A | A | 0.08 | AA |
| Example 7 | | 2 | | 10 | A | A | A | 0.07 | AA |
| Example 8 | | 8 | | 15 | A | A | A | 0.05 | AA |
| Example 9 | | 8 | | 20 | A | A | A | 0.04 | AA |
| Example 10 | | 15 | | 10 | A | A | A | 0.08 | AA |
| Example 11 | | 18 | | 4 | B | A | A | 0.1 | B |
| Example 12 | | 19 | | 27 | B | A | B | 0.06 | A |
| Comp. Ex. 1 | | 10 | | 0 | C*** | B | A | 0.19 | C |
| Comp. Ex. 2 | | 0 | | 15 | C**** | B | C | 0.06 | C |
| Comp. Ex. 3 | | 0.3 | | 10 | C**** | B | B | 0.07 | C |
| Comp. Ex. 4 | | 10 | | 2 | C*** | B | A | 0.12 | C |
| Comp. Ex. 5 | | 25 | | 5 | C | B | A | 0.1 | C |
| Comp. Ex. 6 | | 25 | | 30 | C | B | B | 0.05 | C |
| Comp. Ex. 7 | | 10 | | 33 | A | A | C | 0.04 | B |
| Example 13 | CB-2** | 0.7 | | 20 | A | A | A | 0.06 | AA |

*CB-1: graphitized carbon black (Toka Black #3845, Tokai Carbon)
**CB-2: SiC-based composite graphite black (Nippon Steel chemical Carbon) + silane-coupling agent (KBM573, Shin-Etsu Chemical)
***The film peeled.
****The film wore.

1. A piston ring to be mounted in a ring groove of a piston of an internal combustion engine, the piston ring arranged in the piston groove so that it collides with or slides against the piston, the piston ring having an upper face and a lower face in its axial direction, wherein a resin film is deposited on at least one of the upper face and the lower face of the piston ring, the resin film containing from 0.5 to 20% by volume of a carbon black particle and from 3 to 30% by volume of a solid lubricant particle with respect to the total volume of the resin film.

2. The piston ring according to claim 1, wherein the carbon black particle comprises at least one of a graphitized carbon black particle and a composite graphite black particle.
